(19) United States
(12) Patent Application Publication
(10) Pub. No.: US 2008/0187412 A1
(43) Pub. Date: Aug. 7, 2008

(54) Feeding Device and a Feeding Process For Components

(76) Inventors: Thomas Sturm, Wiedenzhausen (DE); Konrad Liepert, Mering (DE); Jurgen Pfeifer, Meitingen-Erlingen (DE)

Correspondence Address: MCGLEW & TUTTLE, PC, P.O. BOX 9227, SCARBOROUGH STATION, SCARBOROUGH, NY, 10510-9227, US

(21) Appl. No.: 11/911,242

(22) PCT Filed: Mar. 31, 2006
(86) PCT No.: PCT/EP2006/002925

§ 371 Date: Oct. 11, 2007

(30) Foreign Application Priority Data
Apr. 14, 2005 (DE) 20 2005 006 042.9
Dec. 24, 2005 (DE) 20 2005 020 205.3

(51) Int. Cl. B23Q 5/02

(52) U.S. Cl. 414/18

(57) ABSTRACT

The invention relates to a device and a method for feeding motor vehicle body parts (4, 5) having passage openings (6) which are preferably closed on their periphery through a protective fencing (2) having a fence opening (3). The feeding device (7) comprises at least one support (8) on which the components are placed by means of the passage openings (6) outside the protective fencing (2) or are fed together with the support (8). The feeding device (7) also comprises a supporting device (9) having a plurality of spaced apart and individually mobile and controllable gripper devices (18, 19) for alternately retaining and releasing the support (8), thereby allowing the components to be transported along the support (8) through the protective fencing (2) while being separated.

### CROSS REFERENCE TO RELATED APPLICATIONS

This application is a United States National Phase application of International Application PCT/EP2006/002925 and claims the benefit of priority under 35 U.S.C. §119 of DE 20 2005 006 042.9 filed Apr. 14, 2005 and of DE 20 2005 020 205.3 filed Dec. 24, 2005, the entire contents of which are incorporated herein by reference.

### FIELD OF THE INVENTION

The present invention pertains to a feeding device and a feeding process for mechanical components, especially body parts or other vehicle parts.

### BACKGROUND OF THE INVENTION

It is known in practice that body parts of vehicles are fed stacked in a rack to the machining site, where a machining device, e.g., a multiaxial industrial robot, must grasp the components from the stack for machining one by one. The components are separated by the robot. Furthermore, it is known from practice that body parts can be fed by means of rotary tables. The components are removed here by a worker from a stack or container, separated in the process and placed on the rotary table. This method has the drawback that the work time of the worker is utilized insufficiently because the cycle time for the machining is frequently considerably longer than the feeding time needed by the worker.

### SUMMARY OF THE INVENTION

The object of the present invention is to show a better possibility of feeding.

The feeding technique being claimed has the advantage that components can be fed in a stack on a carrier and released in a separated form, the loading of the carrier and the release of the components being able to take place at different ends of the carrier. The support means with its individually controllable gripping means has the advantage that it is possible to convey the component along the carrier from the loading side to the release side.

The components can be lined up on the carrier by means of one or more passage openings and hung up one after another while forming a stack. The passage openings are preferably closed on the circumferential side, but they may alternatively also be open downwardly and/or on one or more sides. The stack can be formed and the loading of the carrier can take place independently from the separation and the release of the individual components. This makes possible the optimal utilization of workers. Their work time for loading and stacking can be uncoupled from the cycle time of the workpiece release and the further machining of the workpieces. Furthermore, it is possible to carry out the loading from the outer side of a machining station and from outside a protective fence due to the special type of the gripping means and the open ends of the carrier, the mechanical separation and further machining of the components taking place within the machining station and the protective fence.

The gripping means, which are spaced apart, hold the carrier airborne or at spaced-apart points, so that the ends of the carrier are free in a desired manner for the loading and release of the components. By alternatingly opening and closing the gripping means in conjunction with a corresponding separating device, the separated components can pass through the gripping means in the manner of a sluice function, while the mechanical stability and positioning of the carrier are preserved. The components can be conveyed now in any desired manner, e.g., by the force of gravity, but, as an alternative, also by an integrated conveying device or the like. The carrier may have any desired orientation, and it is held obliquely with the loading side located on top in the preferred embodiment. As an alternative, the carrier may also be oriented horizontally or vertically. The oblique arrangement has the advantage that an ergonomically favorable and constant loading position is obtained for the worker.

In the simplest embodiment, the separating device can release the components from the stack one by one or in groups and retain the rest of the stack, so that only one component or one group of components will pass through the gripping means at any one time. The separating device can, in addition, ensure the active separation of contiguous components or components that have nested together.

The stacking of the components may be carried out at the feeding device and at the carrier thereof. However, there is maximum safety, especially accident-proofness, due to the components being loaded in and released at different ends of the carrier. This also ensures the above-mentioned uncoupling of the work or cycle times for loading and releasing the components. Furthermore, it is possible to carry out the stack formation at the carrier outside the feeding device, e.g., at a deep-drawing press or another manufacturing device for the components. A carrier already loaded with components is then brought in this case to the feeding device and transferred there to the gripping means for holding and for the further feeding process. This has the advantage that the manual stacking process at the feeding device can be eliminated or reduced.

The feeding device offers various other advantages. It requires little space and can also be placed at unfavorable locations of a machining station. Moreover, it can be adapted to different environmental requirements and also to different components. The design and construction effort as well as the manufacturing costs are low, and the effort for safety measures can be kept low as well. The advantages arising for the components themselves are that getting caught mutually or becoming wedged together is prevented or at least reduced. Moreover, securing against incorrect insertion is achieved in a simple manner. The orientation of the component on the loading side may be different than on the release side. Moreover, via a corresponding outlet, the component can be brought into the desired position during release and optionally be made available in the correct position on a component support. The carrier can be adapted by corresponding design measures.

The feeding device may have various safety means, which guarantee safe, trouble-free and accident-free operation. Using a positive-locking arm locking mechanism, the two gripping means can be prevented from opening simultaneously and releasing the carrier in a mechanically and hence especially reliably operating manner. There also is a mechanical securing means in case of a disturbance in the drive of the gripping means by means of the slide being claimed with the alternatingly engaging crank. It can be guaranteed with a slide securing means that the positive-locking arm locking mechanism can be actuated only in case of complete closure of both gripping means. The gripping means can move only in the intended functional and motion process, as a result of which the carrier held airborne with the stack of components is secured as well.

A component securing means prevents incorrect components from being picked up at the feeding device and from being fed into the machining process. A protective cover at the fence opening prevents human operators from reaching into the work area of the feeding device and the mechanical moving parts thereof, especially gripping means, from the outside in such a manner that may readily cause accident. Rotatable carrying stars, which offer a support for the carrier in each rotation position and can be used, in addition, for guiding the components in a controlled manner, may be present as additional securing means for the carrier at one end or at both ends.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a side view of a feeding device;

FIG. 2 shows a tilted front view of the feeding device according to arrow II in FIG. 1;

FIG. 3 is a side view showing a variant of the feeding device with an outlet and a support for the component;

FIG. 4 is a side view shows another variant of the feeding device for other shapes of components and with another component feed;

FIG. 5 is a front view of a multiple-support feeding device;

FIG. 6 is a side view showing an operating step of the feeding device;

FIG. 7 is a front view showing another operating step of the feeding device;

FIG. 8 is a side view showing another operating step of the feeding device;

FIG. 9 is a front view showing another operating step of the feeding device;

FIG. 10 is a side view showing another operating step of the feeding device;

FIG. 11 is a front view showing another operating step of the feeding device;

FIG. 12 is a side view showing another operating step of the feeding device;

FIG. 13 is a front view showing another operating step of the feeding device;

FIG. 14 is a side view showing an operating step of a variant of the feeding device from FIGS. 1 and 2;

FIG. 15 is a side view showing an operating step of a variant of the feeding device from FIGS. 1 and 2;

FIG. 16 is a side view showing a variation of the gripping means;

FIG. 17 is a partial cross sectional front view showing a variation of the gripping means;

FIG. 18 a partial cross sectional front view showing a variation of the gripping means;

FIG. 19 is a perspective view showing another variant of the feeding device with another gripping means and with securing means;

FIG. 20 is a front view showing another variant of the feeding device with another gripping means and with securing means;

FIG. 21 is a perspective view of a positive-locking arm locking mechanism;

FIG. 22 is a perspective detail view of a slide securing means;

FIG. 23 is a perspective view of another gripping shell;

FIG. 24 is a top view of a carrying star support means;

FIG. 25 is a top view showing a different embodiment of a carrying star support means; and

FIG. 26 is a side view showing a different embodiment of a carrying star support means.

### DESCRIPTION OF THE PREFERRED EMBODIMENTS

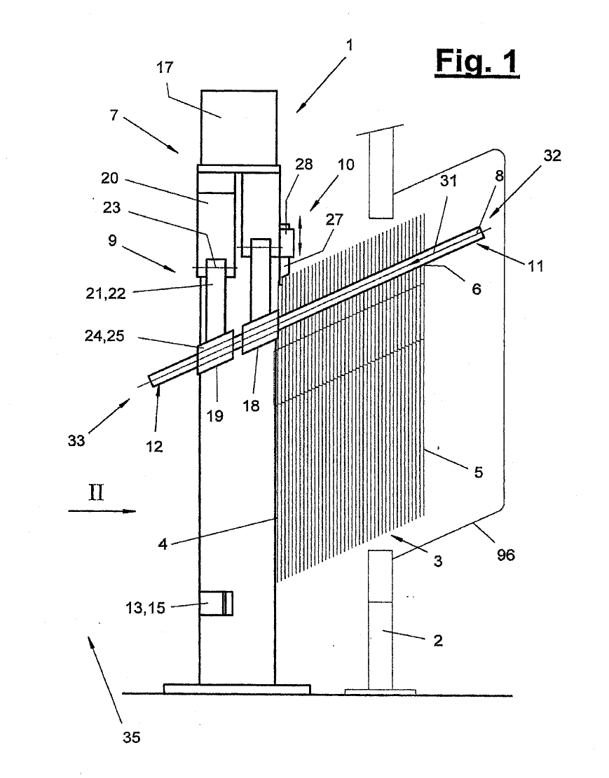

Referring to the drawings in particular, FIG. 1, the present invention pertains to a feeding device (7) and to a feeding process for mechanical components (4, 5), especially body parts or other vehicle parts, and to a machining station (1), which is equipped with one or more such feeding devices (7) and which is surrounded by a protective fence (2) on the outside.

The components (4, 5) may be of any desired type, shape and size. They may be identical to one another or different from one another. In particular, they may also form groups of components.

FIGS. 1 through 3 show components (4, 5) with an essentially flat shape. FIG. 4 shows a variant with pot-shaped components (4, 5). The components (4, 5) have each at least one passage opening (6), which makes lining up on a rod-shaped carrier (8) possible. By means of these passage openings (6), the components (4, 5) hang on the carrier (8). The passage openings (6) are preferably closed on the circumferential side, but, as an alternative, they may also be open downwardly and/or on one or more sides. The carrier (8) may comprise one or more bar-shaped parts. In case of a multipart carrier (8), the parts of the carrier can be attached through a plurality of passage openings (6), which makes possible another type of guiding of the components.

If the components (4, 5) assume a labile position at the carrier (8), a component guide (13) may be present to stabilize the position. This [guide] comprises, e.g., in the variant shown in FIG. 4, a pressure pad (14), which is arranged next to the carrier (8) with parallel orientation. The components can be supported at this bar-shaped pressure pad (14) and assume a defined position and orientation at the carrier (8) as a result. As an alternative or in addition, lateral pressure pads or other types of component guides (13) may be present as well.

In the embodiments shown, the carrier (8) has a straight orientation and a bar shape in some areas. The carrier (8) may comprise one or more such bars in the above-mentioned manner. The cross-sectional shape of the carrier (8) can be adapted to the shape of the passage openings (6) and have a prismatic, round or any other desired shape. The carrier (8) may be substantially smaller than the passage opening (6) or have a corresponding size and essentially fill out the passage opening (6).

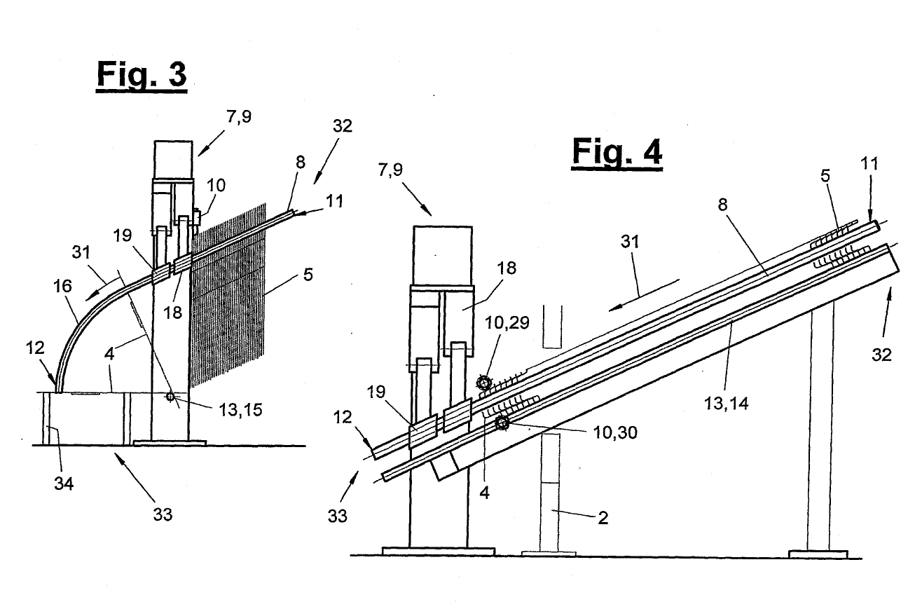

The carrier (8) has two opposite ends (11, 12), of which one end (11) points towards the loading side (32) of the feeding device (7). The other carrier end (12) points towards the release side (33). As is illustrated in FIG. 3, the carrier (8) may have a bent or angular outlet (16), which is arranged, e.g., on the release side (33) and makes it possible to reorient the components (4, 5) during release.

The carrier (8) is directed obliquely in the embodiments being shown, the loading-side carrier end (11) being located higher than the release-side carrier end (12). Due to this orientation, the components (4, 5) at the carrier (8) can slide obliquely downward in the direction of conveying (31) under their own weight. This sliding may optionally be supported by a shaking function at the carrier (8).

As an alternative, a conveying device, which ensures the active conveying of the components, may be arranged in the carrier (8) or externally.

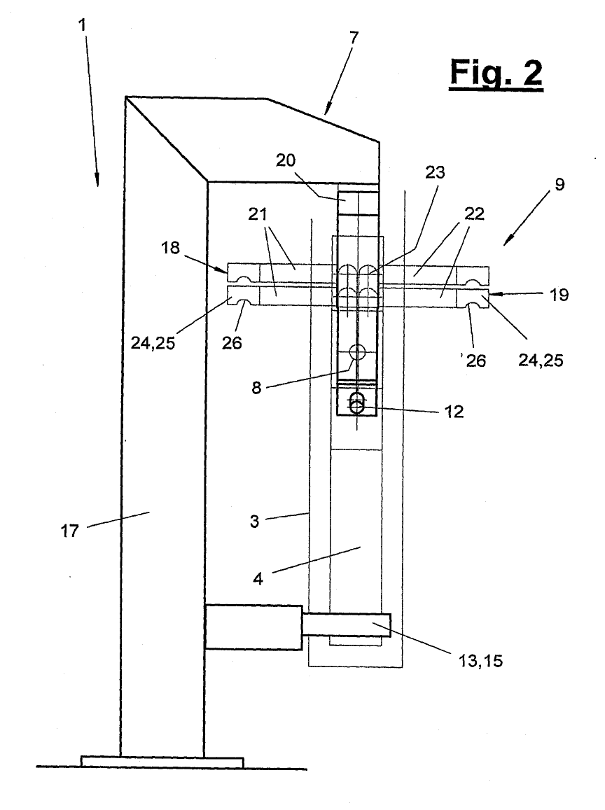

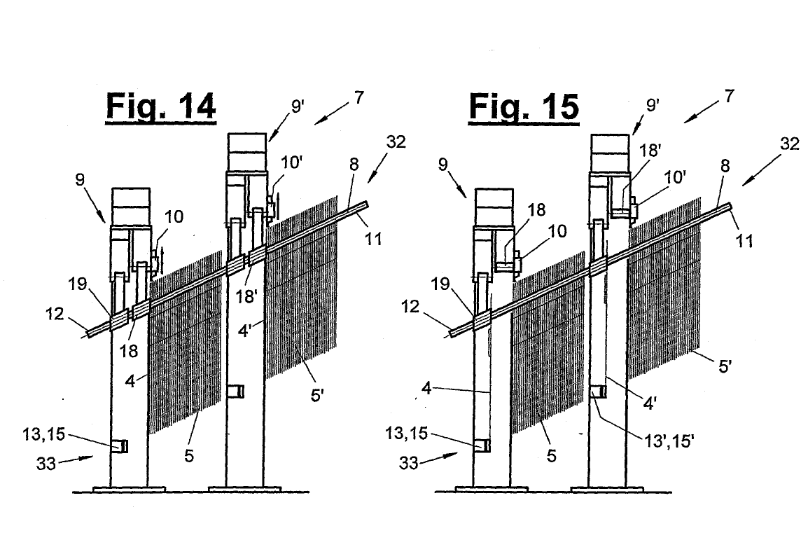

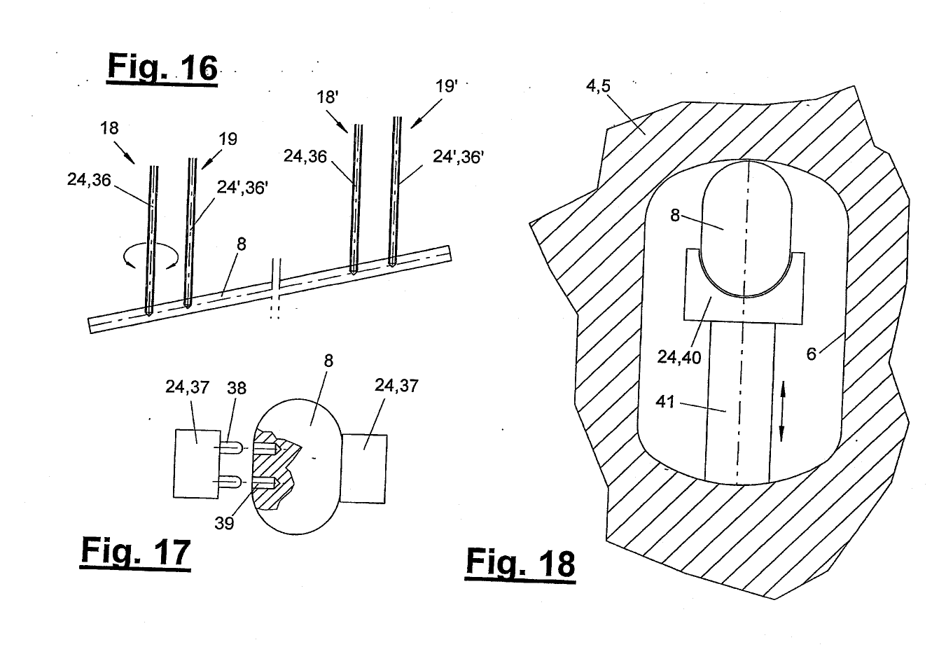

The feeding device (7) shown in detail in FIGS. 1 and 2 has a support means (9) for the carrier (8) with a plurality of gripping means (18, 19), which are located at mutually spaced locations and can be moved and controlled individually, as well as a separating device (10) for the components (4, 5) located at the carrier (8). Two support means (9, 9′) are present for the carrier (8) with a plurality of gripping means (18, 18′, 19, 19′) each in the variant shown in FIGS. 14 and 15. The gripping means (18, 18′, 19, 19′) are preferably of identical design.

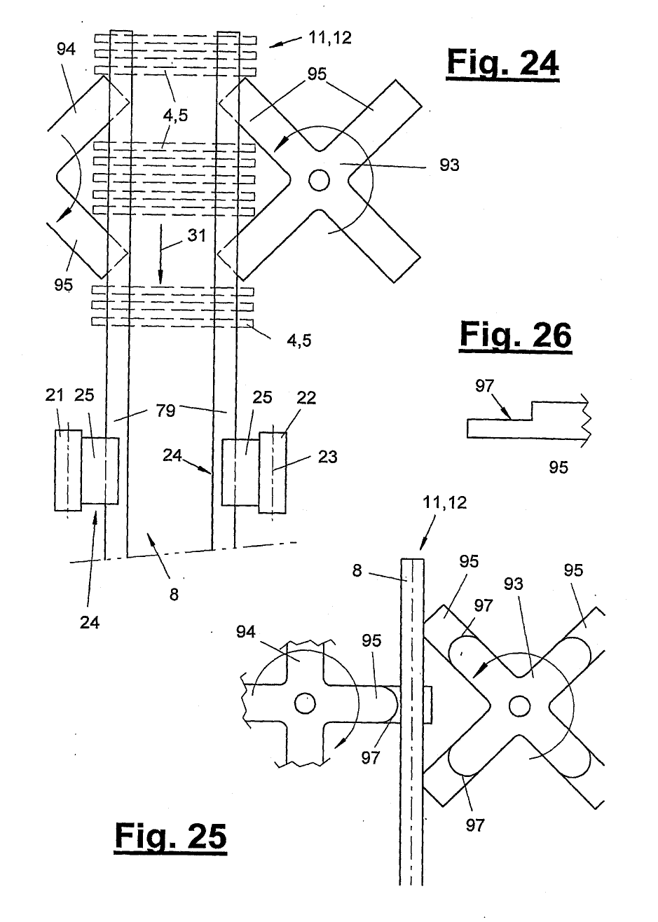

The gripping means (18, 18′, 19, 19′), which can be controlled individually or jointly, hold the carrier (8) with positive locking and/or in a non-positive manner and can be oriented as desired. FIGS. 1 and 2, FIGS. 16 through 18 as well as FIGS. 23 and 24 show various design variants for this.

The gripping means (18, 18′, 19, 19′) can be opened and closed one by one and with an offset in time, as a result of which the separated components (4) can pass through the gripping means (18, 18′, 19, 19′) and reach the release-side carrier end (12). The distance between the gripping means (18, 18′, 19, 19′) in the longitudinal direction (31) of the carrier (8) is selected to be such that at least one component (4) can be accommodated between the gripping means (18, 18′, 19, 19′) without collision. The number of components (4) that can be picked up and the distance depend on the desired separation function and may vary. Separation may also include a group of a plurality of components (4) of the same type or different components (4).

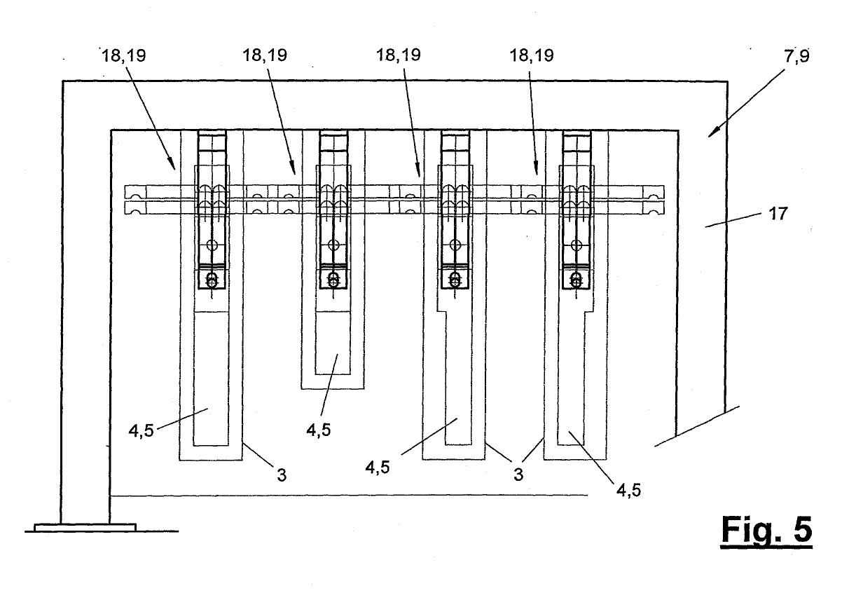

The support means (9, 9′) has a base (17), which is, e.g., L-shaped according to FIGS. 1 through 4. The above-mentioned gripping means (18, 18′, 19, 19′) are preferably arranged suspended at the base (17). FIG. 5 shows an alternative for this with a portal-like base (17), at which a plurality of carriers (8) and a plurality of groups of gripping means (18, 19) are arranged laterally next to each other. This design makes possible the parallel feed of a plurality of components (4, 5), which may also have different designs among themselves, as this is indicated graphically in FIG. 5.

In one embodiment according to FIGS. 1 through 13, the support means (9) has, within each group, two gripping means (18, 19), which hold the carrier (8) airborne. They act on the release-side carrier end (12). As an alternative, more than two gripping means (18, 19), which may optionally also be located at more widely spaced locations from one another in the direction of the carrier, may be present according to the variant shown in FIG. 14. In particular, at least one additional gripping means (18′, 19′) or also another group of the gripping means (18′, 19′) shown may act on the carrier (8) at a point located upwards from the carrier in case of very long carriers (8) or in case of very heavy components (4, 5).

The gripping means (18, 18′, 19, 19′) belonging to one group are arranged in case of oblique carrier orientation at different heights at the base (17). The gripping means (18, 18′, 19, 19′) are oriented such that they can hold the carrier (8) in the desired oblique position one by one and together.

In the exemplary embodiments shown, each gripping means (18, 18′, 19, 19′) has one or more mobile gripping elements (24, 24′) each, which fix, especially clamp, the carrier (8) in the closed position, and release it in the released position to the extent that the component (4) can pass by the released gripping point at the carrier (8).

In one embodiment according to FIGS. 1 through 15, the gripping means (18, 18′, 19, 19′) have a tong-like design and have two mobile supporting arms (21, 22) each, which carry at the lower end the gripping elements (24, 24′), which are designed as paired gripping shells (25) in this variant. The supporting arms (21, 22) are arranged next to each other at right angles to the longitudinal axis of the carrier and are oriented in parallel. In the closed position, the two gripping shells (25) are located opposite each other and clamp the carrier (8) between them. The preferably vertically directed supporting arms (21, 22) have a drag bearing (23) each at the top end with a pivoting drive, not shown. For opening, the supporting arms (21, 22) can be pivoted upwards by 90° into the horizontal position indicated by broken line in FIG. 2, in which passage of the component is possible. The supporting arms (21, 22) are arranged at a base part (20) each, which makes possible the said height adjustment at the base (17). This may be an internal height adjustment with a linear drive. As an alternative, the base part (20) may be designed as a bracket having different lengths.

The gripping shells (25) can be arranged obliquely at the supporting arms (21, 22) corresponding to the slope of the carrier and have a likewise oblique mount (26) on the inner side for gripping the carrier (8) in a positive-locking manner. The support (26) may have, e.g., the shape of a groove and is adapted to the acted-on mounting contour of the carrier (8) in a positive-locking manner. As an alternative, half-ring-shaped clamping points with a recess located inbetween may be arranged at the shell ends and form axially spaced, defined clamping points. The gripping shells (25) may have, furthermore, a locking means (not shown), which additionally fixes and holds them together in the clamped position at the carrier (8).

FIGS. 16 through 18 as well as FIGS. 23 and 25 show different possible design variants of the gripping means (18, 18′, 19, 19′) and the gripping elements (24, 24′). In the variant according to FIG. 16, the gripping elements (24, 24′) are designed as screw spindles (36, 36′), which can be fed into corresponding screw openings at the carrier (8) and can be screwed in by a few revolutions. The carrier (8) hangs in the screw spindles (36, 36′) in the screwed-in position. This embodiment variant is especially suitable for feeding devices (7) that are equipped with a plurality of support means (9, 9′) and a plurality of groups of gripping means (18, 18′, 19, 19′), the carrier (8) being always held and supported by two screw spindles (36, 36′) together, located at spaced locations from one another in the direction of the carrier. In a variant of the embodiment shown, the screw spindles (36, 36′) may also act on the carrier (8) from the other side depending on the size and the type of the components (4, 4′).

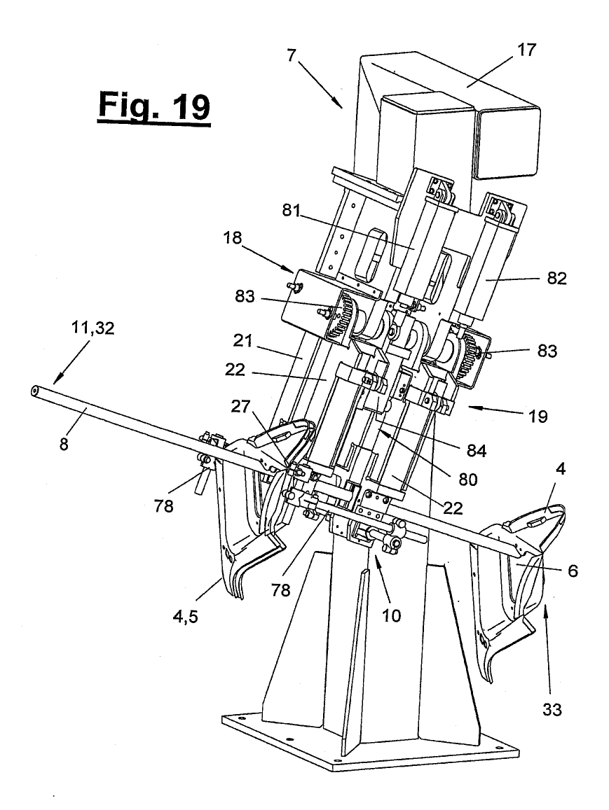

FIG. 17 shows a positive-locking clamping or tensioning variant, in which the gripping elements (24) are designed as clamping jaws (37) with one or more projecting pins (38), which mesh with fitting opposite openings (39) at the carrier (8). Similarly to the gripping shells (25), the clamping jaws (37) can be fed by means of pivotable supporting arms or in another manner in the engaged position at the carrier (8) laterally or from another direction and again retracted for release.

In the variant according to FIG. 18, which is suitable above all for smaller components (4, 5), the gripping elements (24) are designed as support shells (40), which supportingly engage the carrier (8) from below and can be moved vertically up and down by means of a feed mechanism (41), e.g., in the form of a lifting cylinder.

In the variant according to FIG. 23, the carrier (8) comprises a preferably cylindrical round part (73) and a narrower support strip (74), which is arranged under it and which is provided with a passage opening (75) in the area of the gripping elements (24). The gripping elements (24) comprise two shells (25) in this case as well, which grasp the carrier (8) with one another on both sides in a positive-locking manner, so that the carrier (8) is held in such a way that it rotates in unison and is secured against rotation and pushing. The shell (25) shown as a single shell in FIG. 23 has two laterally spaced-apart support fingers (76) for this, one of which is arranged under and the other above the round part (73). Both support fingers (76) project in the transverse direction beyond the center line of the round part (73) and are able to hold this even alone. Recesses (77), which are engaged by the support fingers (76) of the opposite shell having a complementary shape, are present opposite the support fingers (76) on the other side of the round part (73). The lower support fingers (76) of both shells (25) also extend through the passage (75) and fix the carrier (8) in the closed position against slipping off axially. Outside guide cams may be present at the lower support fingers (76) in order to make it possible to reach the passage (75) with certainty during the closing of the shells (25) and possibly also to pull the carrier (8) into position by a certain amount. The two shells (25) otherwise also have half-round lateral mounts adapted in shape to the round part (73).

The separating device (10) may have various designs. In the exemplary embodiment according to FIGS. 1 through 3, it comprises one or more mobile separating fingers (27) with a corresponding setting means (28). The separating fingers (27) are used for the controlled release of the component (4) that is the frontmost component in the direction of conveying and for retaining the other components (5) located behind it in the stack. One or more such separating fingers (27) may be present depending on the type and the size of the components (4, 5). In the exemplary embodiment of FIGS. 1 through 3, a single separating finger (27) is arranged on the top side of the components (4, 5), which finger is moved vertically up and down by the setting device (28), and it reaches into a free space between the components (4, 5) suspended in the stack.

FIG. 4 shows a variant of the separating device (10), which is especially suitable for nested components (4, 5) engaging one another in a positive-locking manner. This separating device (10) ensures the active separation and mutual detachment of the nested components (4, 5), and a conveying pulse is also generated for the separated component (4) located in front. In the embodiment shown, the separating device (10) comprises two rotatable gears (29, 30), which are located opposite each other, are designed as spur gears and are driven in a controlled manner. With their teeth they mesh between the adjacent edges of the components (4, 5) in a positive-locking manner and separate these during their rotary motion.

The separating device (10) is arranged in the direction of conveying (31) in front of the release-side gripping means (18, 19) in both embodiments described and ensures separation of the particular frontmost component (4) in the stack in front of the gripping means (18, 19). As an alternative, a group of a plurality of components (4) can be separated as well.

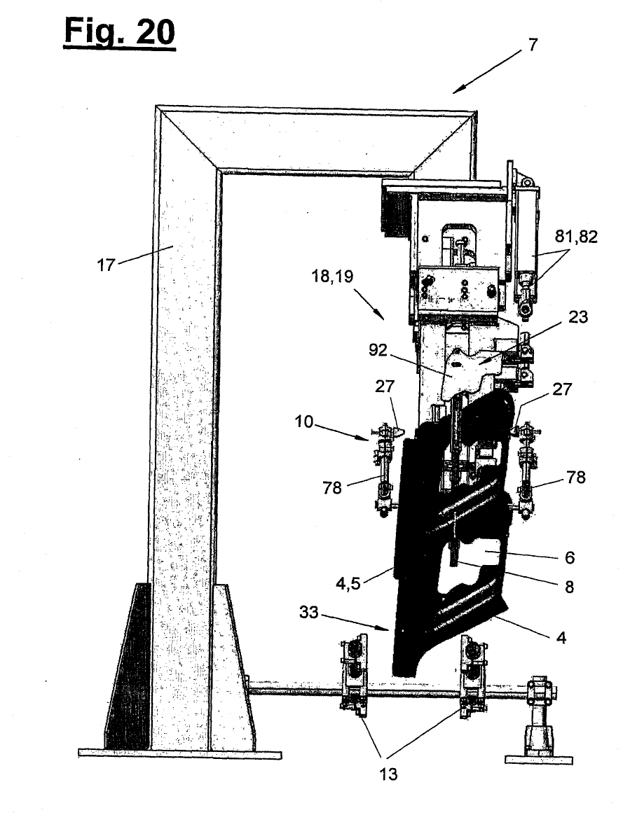

The separating device (10) is arranged movably and is connected, e.g., to the lower gripping means (19) in the exemplary embodiment according to FIGS. 19 and 20. One or more separating fingers (27) are located here at one or more frame-like extension arms (78), which are connected to one or both supporting arms (21, 22) and extend beyond the upper gripping means (18) along the carrier (8). In addition, a stop (not shown) is also present at the front gripping means (18) for the frontmost component (4) in the stack of components (5). When the lower gripping means (19) is opened, the separating device (10) is also automatically opened in this arrangement. The separating fingers (27) pivoted out with the supporting arms (21, 22) release the stack of components (5), which can slide downwards, and the frontmost component (4) comes into contact with the stop of the upper gripping means (18). The axial distance between the stop and the separating fingers (27) in the longitudinal direction of the carrier is selected specifically for the component, so that the separating fingers (27), which are again pivoted in during the closure of the separating device (10), extend behind the frontmost component (4) in the stack (5) and support and fix the next stack against sliding off. When the upper gripping means (18) subsequently opens, the stop is also released and the component (4) can slide at the carrier (8) to the release side (33). The cycle starts anew after the closure of the upper gripping means (18).

In another variant, not shown, the separating device (10) may have a spreading means acting with magnetic force for spacing apart the components (4) in the stack of components (5). This may be, e.g., an electromagnetic spreading means or switchable permanent magnets or the like. Adjacent components (4) repel each other due to magnetization of the same sign and form a sufficiently large and defined free space or gap, into which the separating finger (27) or another part of the separating device (10) can extend. Magnetic repelling reactions can be generated by eddy currents in the case of components (4) that are made of non-magnetizable materials but are electrically conductive.

The feeding device (7) may also have a component guide (13) in the area of the gripping means (18, 19), which said guide may be, e.g., in FIGS. 1 and 2, a stop (15), which is arranged under the gripping means (19, 18) at the base (17) and which acts on the lower edge of the component. This stop (15) may be provided with an adjusting drive and can be moved into and out of the path of motion of the components (4, 5) when needed. The stop (15) prevents the separated components (4) from swinging back and getting wedged during the conveying motion along the carrier (8) in the extended position.

FIG. 20 shows another variant of the component guide (13), which comprises, e.g., two parallel strips or braking brooms, which are arranged on the release side (33) and which laterally guide a component (4), which is susceptible to swinging and pendular motion, during the slipping motion.

In the variant according to FIG. 3, the stop (15) may have an additional function and be permanently located in the range of motion of the components (4, 5). It acts in this case as an abutment for the lower edge of the component, as a result of which the component (4) performs a pivoting motion about one or more axes while sliding down along the arched outlet (16) and assumes a final position that differs from the position in which it was fed on the loading side (32). The component (4) may be deposited for this, e.g., obliquely or horizontally on a component support (34) and brought into a defined position by means of guides or the like. The component (4) can be processed in this position. As an alternative, it can be grasped by a multiaxial industrial robot or another machining means, a conveyor or the like and moved further from this defined position for the further machining at another site. The outlet (16) may likewise be movable and driven in a controlled manner to make it possible to remove the component.

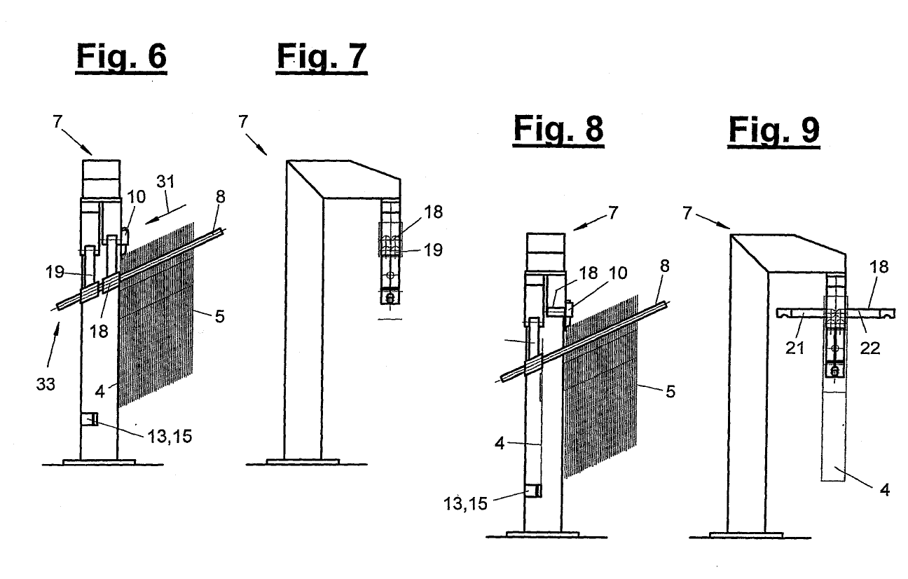

FIGS. 6 through 13 illustrate the operating process of the feeding device (7) in four steps, the feeding device (7) being always shown in a side view and a tilted front view corresponding to the views in FIGS. 1 and 2.

FIGS. 6 and 7 show the starting position of the feeding device (7) with a stack of components (4, 5) at the carrier (8), which is in contact with the separating device (10) in the direction of conveying (31). The separating device (10) has first released the frontmost component (4) in the second step according to FIGS. 8 and 9 and retains the next stack of components (5). The gripping means (18), which is the front and upper gripping means in the direction of conveying (31), has subsequently opened and spread apart the supporting arms (21, 22). As a result, the separated component (4) can slide along the carrier (8) and strike the second, lower and still closed gripping means (19) as well as optionally the component guide (13, 15). The closed gripping means (19) fixes the carrier (8) with the rest of the stack of components in this situation shown in FIGS. 8 and 9.

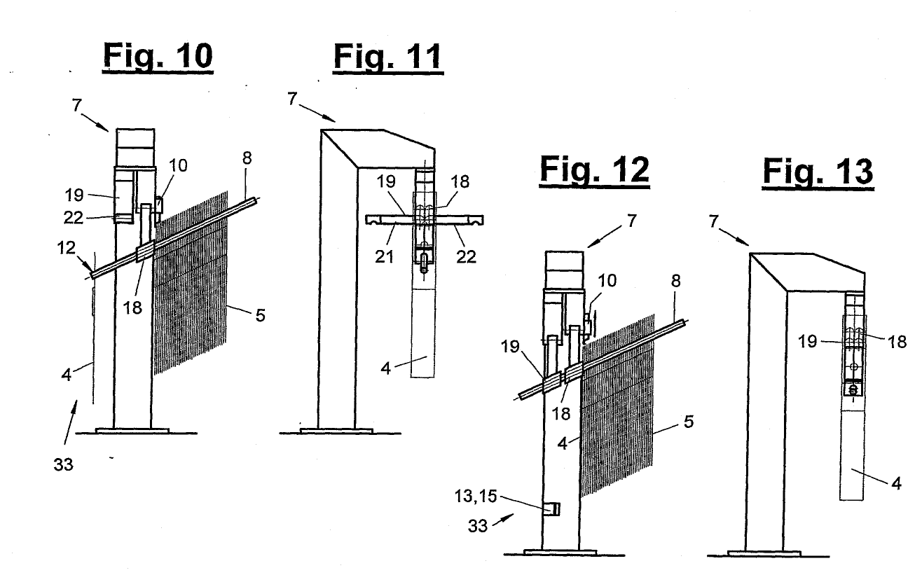

The upper gripping means (18) closes behind the separated component (4) in the third step according to FIGS. 10 and 11, grasps the carrier (8) and fixes it with the rest of the stack of components (5). The rear or lower gripping means (19) subsequently opens by spreading apart the pivot arms (21, 22), so that the separated component (4) can slide off unhindered and reach the release-side end (12) of the carrier. It is removed here in a suitable manner and forwarded or subjected to further machining. This state is illustrated by FIGS. 10 and 11.

In the fourth and last operating step, the rear gripping means (19) also closes again and likewise grasps the carrier (8). The separating device (10) subsequently releases the next component (4) and retains the rest of the stack of components (5), after which the above-described cycle starts anew.

The variant of the feeding device (7) with two or more support means (9, 9′) arranged at spaced locations along the carrier (8), which the feeding device is shown in FIG. 14 and 15, operates in a similar manner, and the carrier (8) is held with gripping means (18, 18′, 19, 19′) during each phase at at least two points located at spaced locations from one another. The support means (9, 9′) and their separating devices (10, 10′) as well as their component guides (13, 13′, 15, 15′) and their gripping means (18, 18′, 19, 19′) are preferably of the same type and correspond in the embodiment being shown to the variant according to FIGS. 1 and 2. A separate stack of components (5, 5′) is formed at each support means (9, 9′) at the carrier (8), and the separation and the further conveying of the respective components (4, 4′) located in front preferably take place simultaneously.

FIG. 14 shows the starting position of the support means (9, 9′) with the release of the respective frontmost components (4, 4′) and the retention of the next stack (5, 5′). The respective gripping means (18, 18′) located in the front have opened in the next position shown in FIG. 15, as a result of which the separated component (4, 4′) slides along the carrier (8) and strikes the second, still closed gripping means (19, 19′) belonging to it. These two gripping means (19, 19′) now fix the carrier (8) in a secured position. The gripping means (18, 18′) close in the next step, not shown, after which the other gripping means (19, 19′) open and make possible the further conveying of the separated components (4, 4′). The component (4′) now slides to the end of the stack of components (5). The cycle then starts anew.

The feeding device (7) is preferably arranged within the protective fence (2) within the machining station (1) and extends with its carrier (8) through an opening (3) in the fence to the outside only slightly. The opening (3) in the fence forms a passage for the stack of components (5), which is at least extensively adapted to the components (4, 5) in terms of its contours. The worker (not shown) can thus attach the components (5) to the carrier (8) outside the protective fence (2). This may be carried out manually or by means of a loading means, which is docked with the end (11) of the carrier. As an alternative, loading may also be carried out mechanically and fully automatically. To increase accident-proofness, a protective cover (96), which extends outwardly in the direction of the carrier and surrounds the opening (3) in the fence and the projecting carrier (8) as well as the stack of components (5) on at least three sides, may be arranged around the opening (3) in the fence according to FIG. 1. The protective cover (96) prevents a worker from reaching with his hand from the outside into the hazardous area of the feeding device (7) and especially into the area of the gripping means (18, 19).

The release side (33) of the feeding device (7) is located within the protective fence (2), where the work area (35) for picking up and further machining the separated components (4) is located as well. The feeding device (7) and its mobile driven components have a suitable control (not shown), which may be coupled with the cell or station control and the process controls for the further machining. The mobile parts of the support means (9) have suitable drives (not shown), which are connected to this control. Furthermore, the feeding device (7) may have measuring and control means, especially force, position or motion sensors, in order to monitor the components of the feeding device (7) for correct operation and the components (4, 5) for correct loading and position and to trigger an alarm in case of malfunction. In particular, the presence of components (4, 5) at the carrier (8) and a possible need for loading can be detected and reported.

In the embodiments shown, the carrier (8) is arranged stationarily at the feeding device (7) and maintains its position during the alternating grasping and releasing of the gripping means (18, 18′, 19, 19′). The components (4, 4′, 5, 5′) are stacked at the carrier (8) by attaching components (5, 5′) on the loading side (32) one by one or in groups. As an alternative, the carrier (8) may be replaceable and portable, and stacking may take place at another site, e.g., at a deep-drawing press for sheet metal parts. The components (4, 5) are attached immediately to a carrier (8) in this case on removal from the press and fixed by clamps or other suitable holders. The loaded carrier (8) is then conveyed with a suitable conveying means to the feeding device (7) and attached and transferred there with its release-side carrier end (12) into the opened, empty gripping means (18, 19). The clamps or other temporary holders are subsequently removed, so that the carrier (8) with the stack of components is ready for the above-described feeding and separation function. In a variation of this, the components (4) may be attached to a suitable carrying means at the production site, e.g., a deep-drawing press for sheet metal parts, and conveyed with this to the feeding device (7), where the stack of components (5) is pushed over from the docked carrying means to the carrier (8). The carrying means can subsequently return for reloading.

To support the sliding motion of the component at the carrier (8), a shaking device (not shown) may be present. This may be associated with the gripping means (18, 18′, 19, 19′) or other parts of the support means (9, 9′). As is shown in FIG. 20, a component securing mechanism (92), which is adapted to the intended and approved components (4) and lets only these through, may be arranged at the loading-side end (11) of the carrier. The component securing mechanism (92) may be, e.g., a disk, which is contoured corresponding to the passage opening (6) and which can be passed through with that passage opening (6) only.

Furthermore, it is possible to adjust the position and/or the slope of the carrier (8). For example, the gripping means (18, 18′, 19, 19′) can be correspondingly adapted in design for this.

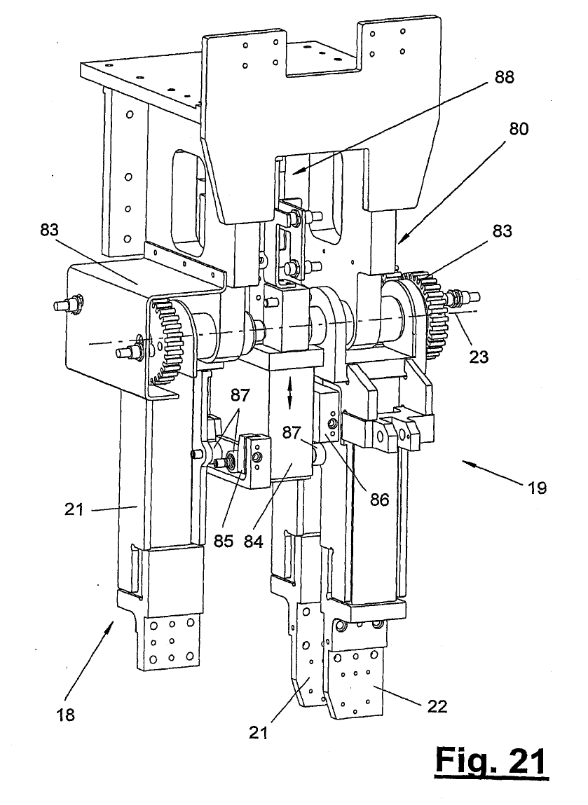

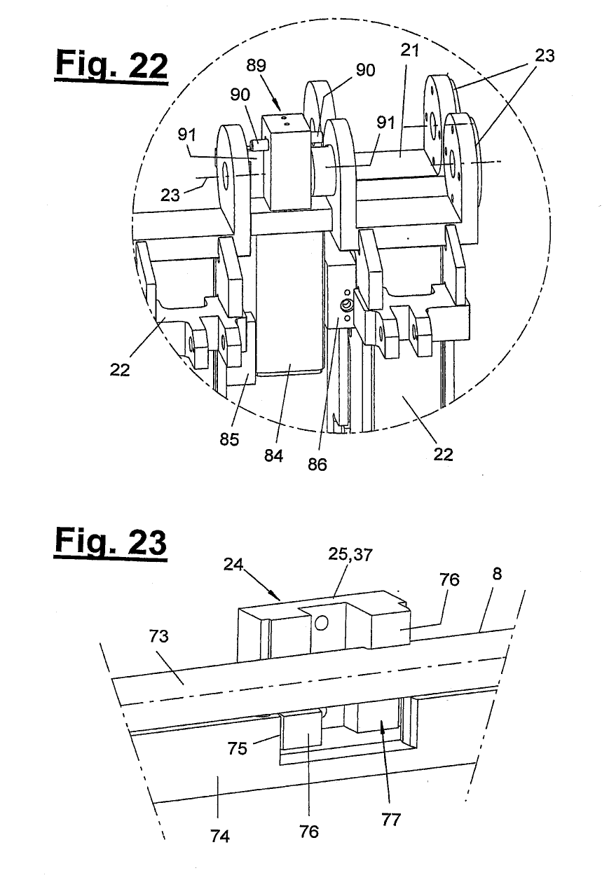

The feeding device (7) may have various securing means for the gripping means (18, 19). As is shown in FIGS. 21 and 22, a positive-locking arm locking mechanism (80) may be present for the pivotable supporting arms (21, 22) of the paired adjacent gripping means (18, 19) and (18′, 19′). The arm locking mechanism (80) ensures that the gripping means (18, 19) and (18′, 19′) can be opened only alternatingly but not simultaneously. It comprises, e.g., a slide (84), which is arranged between the gripping means (18, 19), (18′, 19′), is vertically mobile by means of a drive (88) and carries on both sides a crank (85, 86), which cooperates with rollers (87) on the adjacent sides of the supporting arms (21, 22). The cranks (85, 86) are of a clamp-like design and extend around the associated rollers (87) in a clamped connection during the motion of the slide.

As is shown in FIG. 21, the two cranks (85, 86) are arranged at different heights and are directed against each other. When the left-hand crank (85) clamps the rollers (87) of the upper gripping means (18), e.g., according to FIG. 21, the other crank (86) releases the rollers (87) and the supporting arms (21, 22) of the other gripping means (19) in this position of the slide, so that the latter gripping means (19) can be opened. After closure of the lower gripping means (19), the drive (88) is first actuated and the slide (84) is lowered, so that the right-hand crank (86) blocks the lower gripping means (19) and at the same time disengages the left-hand crank (85) and makes it possible to open the upper gripping means (18) by the subsequent drive motion.

FIGS. 19 and 20 show possible embodiments of the drive technique of the supporting arms (21, 22). The arm drives (81, 82) for the upper and lower gripping means (18, 19) may be of identical design and comprise, e.g., pneumatic or hydraulic cylinders, which act on a supporting arm (22) of the pair of arms in an articulated manner and rotate this [arm] about its pivot axis (23). The driving motion can be transmitted to the other supporting arm (21) by means of a gear mechanism (83), so that this [supporting arm] will pivot in the opposite direction about its pivot axis (23). The pivoting kinematics of the two supporting arms (21, 22) can be made identical or different as needed by a corresponding design of the gear mechanism. For example, the pivot arms (21, 22) may have different pivot angles or pivoting widths. On the other hand., the drag bearings (23) also do not need to be located at the same level, as in the exemplary embodiments shown, and the supporting arms (21, 22) may also have different lengths. Different embodiments may be recommended, e.g., in case of interfering contours.

Furthermore, a slide securing means (89), which permits a motion of the slide (84) to take place only when the supporting arms (21, 22) of both gripping means (18, 19), (18′, 19′) are closed, may be present to increase accident-proofness. According to FIG. 22, laterally projecting pins (90), which cooperate with semi-round blocking cams (91) on the four supporting arms (21, 22), are present for this purpose at the head of the slide (84) according to FIG. 22. The blocking cams (91) with their flat cut-off sides are vertical in the closed position and offer a passage for the pins (90), so that the slide (84) can be raised or lowered by the drive (88). The blocking cams (91) directed centrally with the drag bearings (23) turn blockingly into the path of motion of the pins (90) with their arched curved part when a supporting arm (21, 22) moves pivotingly out of the starting position or gripped position of the carrier (8). The slide (84) cannot be moved in this case and the positive-locking arm locking mechanism (80) at the supporting arms of the other gripping means cannot consequently be opened, either. It is ensured hereby that at least one gripping means (18, 19) is always closed and fixes the carrier (8).

FIGS. 24 through 26 show a possibility for additionally supporting one or both carrier ends (11, 12). One or more, e.g., two, rotatably mounted carrying stars (93, 94) with a plurality of, e.g., four brackets (95) arranged crosswise are present for this. The carrying star or stars (93, 94) can be actuated and rotated manually by a worker during the transfer of the component. As an alternative, they may have a motor drive, which is actuated manually by the worker or automatically by a suitable control or by the control of the feeding device (7).

The carrier (8) always lies on at least one bracket (95) in all rotation positions of the carrying star or stars (93, 94) and is secured against falling out. The length and width of the brackets (95) and the lateral distance between the axes of rotation of the carrying stars (93, 94) and the carrier (8) are correspondingly coordinated with this. A single carrying star (93, 94) is sufficient in the simplest case. Two carrying starts (93, 94) located opposite each other at a one-part carrier (8) act together in the variant according to FIG. 25, their rotation positions being selected such that they always extend with their brackets (95) into the opposite gap of the bracket of the other carrying star (93, 94) in the manner of teeth. Conveying of the component, which can take place similarly to the case of a gear conveyor, is also possible with this design during the rotation of the carrying star. One or more components (4) fit into the particular free space between adjacent brackets (95).

FIG. 24 shows a variant in which the carrier has a multipart design and comprises, e.g., two parallel individual bars (79), at which the components (4) are guided suspended with their passage openings. The individual bars (79) are supported in this case by a carrying star (93, 94) arranged on the outside. The carrying stars (93, 94) are coordinated and synchronized with one another with their opposite rotary motions such that the components (4) can be conveyed and conveyed further one by one or in groups during the motion of the star. The orientation of the arm and the rotation positions of the two carrying stars (93, 94) may be the same in this case.

At their free front end, the brackets (95) may have a guide cam or centering cam (97), which is arranged set back in relation to the front end of the bracket. The bracket end acquires for this the stepped shape shown in a side view in FIG. 26. The guide cam (97) can exert a guiding action on the components (4). In addition, it can counteract possible lateral displacements of the carrier (8) and stabilize the orientation thereof. The carrier (8) now lies on the front stepped section of the brackets (95).

FIG. 24 also shows, on the other hand, the gripping kinematics provided in such a bar arrangement. The supporting arms (21, 22) may be laterally spaced apart from one another in this case and equipped with a gripping shell (25), which is pressed, e.g., from the outside in the gripping position against the adjacent individual bar (79). The supporting arms (21, 22) with their shells (25) clamp the individual bars (79), which are spaced apart, e.g., by means of a spacer (not shown), in the closed position in a tong-like manner. A shell design as shown in FIG. 23 with upper and lower support fingers (76), which project over the middle of the bar and ensure securing holding of the individual bar (79) even when the shell (25) is not fully closed and pressed on, is recommended in case of such an embodiment.

Various modifications of the embodiments shown are possible. On the one hand, the gripping means (18, 18′, 19, 19′) may have any other desired design embodiment, arrangement and alternating gripping function. The passage of the components (4, 4′, 5, 5′) with the alternating opening and closing as well as the passage of the components in the meantime may be different as well. Heavily loaded carriers (8) can be held at points separated in space and better supported by a multiple arrangement of gripper groups. The opening and closing operations can take place simultaneously in groups in this case. Separation and conveying of the individual components may also take place now at each group. A plurality of stacks of components can be formed in case of a multiple arrangement of gripper groups.

While specific embodiments of the invention have been shown and described in detail to illustrate the application of the principles of the invention, it will be understood that the invention may be embodied otherwise without departing from such principles.

1. A feeding device for feeding workpiece components, the device comprising:
a plurality of workpiece components, each component defining a component opening;
a component support element, said components being removably attached to said component support element such that said component support element extends through each component opening;
a separating means for separating said components located on said component support element; and
a support element with a plurality of individually movable and controllable gripping means for alternatingly holding and releasing said component support element, one gripping means being located at a spaced location from another gripping means.

2. A feeding device in accordance with claim 1, wherein one end of said component support element is located at a loading side and another end of said component support element is located at a release side, each end of said component support element being free, wherein one of said gripping means holds said component support element at said release side of said component support element, said component support element having an angular or bent outlet on said release side.

3. A feeding device in accordance with claim 1, wherein said support element has two said gripping means, wherein said space between one gripping means and another gripping means corresponds to the a size of one of said components.

4. A feeding device in accordance with claim 1, wherein one of said gripping means holds said component support element airborne.

5. (canceled)

6. A feeding device in accordance with claim 1, wherein a first gripping means and a second gripping means hold said component support element at at least two points on said component support element, one point being located on said component support element at a spaced location from another point on said component support element.

7. (canceled)

8. A feeding device in accordance claim 2, wherein a first gripping means and a second gripping means hold said component support element obliquely such that said loading-side of said component support element end is located at a position that is higher than a position of said release-side of said component support element end.

9. A feeding device in accordance with claim 1, wherein said support element is connected to a base such that each said gripping means extends parallel to said base when each said gripping means is in a gripping position, one of said gripping means being arranged at a position that is different than a position of another gripping means with respect to said base.

10. (canceled)

11. A feeding device in accordance with claim 1, wherein each said gripping means has one or more movable gripping elements, each movable gripping element engaging said component support element in a closed position such that said component support element is in a fixed position when said movable gripping element is in said closed position, each movable gripping element opening to a release position such that said component support element is released when said movable gripping element in the released position.

12. A feeding device in accordance with claim 1, wherein each said gripping means is of a tong-like structure, each said gripping means having two movable supporting arms with end-side gripping shells, each said gripping shell having an oblique mount for grasping said component support element in a positive-locking manner, each said gripping means being connected to a base part, said supporting arms being pivotably mounted to said base part such that one supporting arm is adjacent to another supporting arm, each supporting arm being driven in a controllable manner, said base part being adjustable in height at said base.

13-14. (canceled)

15. A feeding device in accordance claim 1, wherein each pair of adjacent gripping means has a positive-locking arm locking mechanism for preventing one gripping means from being simultaneously opened or closed when another gripping means is opened or closed, said positive-locking arm locking mechanism having a driven slide with crank elements, each crank element alternatingly engaging a roller at each said gripping means in a positive-locking securing manner, said positive-locking arm locking mechanism having a slide securing means for providing a sliding motion only when each said gripping means is in a closed position.

16-18. (canceled)

19. A feeding device in accordance with claim 1, wherein said separating means has at least one mobile separating finger with an adjusting means for retaining said one of said components and for releasing one of said components in a controlled manner, said separating means being fixed at a location adjacent said support element.

20. (canceled)

21. A feeding device in accordance with claim 1, wherein said separating means is mounted to a lower gripping means for movement such that movement of said lower gripping means corresponds with movement of said lower gripping means, said separating means having at least one said separating finger connected to said lower gripping means via an extension arm, said at least one separating finger being connected to a stop at said upper gripping means.

22. (canceled)

23. A feeding device in accordance with claim 1, wherein said separating device has at least one gear, said gear being rotatable and driven in a controlled manner, said at least one gear meshing with one of said components in a positive-locking manner, said at least one gear releasing one of said components in a controlled manner.

24. A feeding device in accordance with claim 1, further comprising a component guide, said component guide having at least one pressure pad arranged along said component support element, said component guide having at least one stop arranged on a release side of said component support element, said stop being movable in a controllable manner.

25-27. (canceled)

28. A feeding device in accordance with claim 1, wherein said component support element has one or more carrying bars, each carrying bar having a straight orientation in at least in some areas.

29. (canceled)

30. A feeding device in accordance with claim 2, wherein said component support element has a component securing element adapted to the contour of the component opening on said loading side.

31. A feeding device in accordance with claim 2, further comprising a component support structure on said release side.

32. A feeding device in accordance with claim 1, wherein said support element has a base with a plurality of laterally adjacent pairs of said gripping means.

33. A feeding device in accordance with claim 1, further comprising a protective fence having a defined protective fence opening, wherein said support element and said plurality of gripping means are arranged within said protective fence and said component support element extends outwardly through said protective fence opening, said protective fence opening being of a size such that said components pass through said protective fence opening.

34. A feeding device in accordance with claim 33, wherein a protective cover extending outwardly from said protective fence is arranged at said protective fence opening, whereby a loading side of said component support element is located at a position outside said protective fence and a release side of said component support element is located at a position inside said protective fence.

35. (canceled)

36. A feeding device in accordance with claim 1, wherein said component support element is arranged such that said component support element can be removed and replaced.

37. A feeding device in accordance with claim 1, wherein one or more supporting and rotatable carrying elements are arranged at at least one end of said component support element.

38. A machining station for components, the machining station comprising:
a protective fence surrounding a machine work area;
a conveying device comprising:
a plurality of workpiece components, each component defining a component opening;
a bar-shaped component carrying element for receiving and releasing said components, said component carrying element extending through each component opening after said component carrying element receives each component;
a separating means for separating said components received by said component carrying element; and
a support element having a plurality of individually movable and controllable gripping means for alternatingly holding and releasing said component carrying element, one gripping means being located at a spaced location from another gripping means.

39. A process for feeding components, the process comprising the steps of:
providing a plurality of components, each component defining a component opening;
providing a bar-shaped support means for receiving said plurality of components;
providing a protective fence having a defined protective fence openings;
loading said components onto said bar-shaped support means at a loading position to form a stack of components, said loading position being a location outside said protective fence or a position within said protective fencing opening;
providing a separating means for separating one component from another component;
separating said components with said separating means;
conveying said components one by one from a loading side of said bar-shaped support means to a release side of said bar-shaped support means after said components have been separated with said separating means.

40. A process in accordance with claim 39, wherein said bar-shaped support means is alternatingly held and released with a plurality of mutually spaced and individually movable gripping means during the conveying and the separation of said components.
